(19) United States
(12) Patent Application Publication
(10) Pub. No.: US 2002/0065999 A1
(43) Pub. Date: May 30, 2002

(54) Data backup system, method therefor and data storage

(76) Inventors: Toshihiko Kikuchi, Yokohama-shi (JP); Takashi Miki, Yokohama-shi (JP); Takahiro Morimoto, Yokohama-shi (JP); Daisuke Kawakatsu, Yokohama-shi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/042,268

(22) Filed: Jan. 11, 2002

Related U.S. Application Data
(63) Continuation of application No. 09/349,158, filed on Jul. 8, 1999.

(30) Foreign Application Priority Data
Jul. 8, 1998 (JP) 10-193127

(51) Int. Cl. G06F 12/16

(52) U.S. Cl. 711/162; 707/204

(57) ABSTRACT

The names of objective files, a backup sequence and a restore sequence are stored in a configuration tables so as to correspond to one another for the purpose of performing file backup and restoration, based on conditions respectively inherent in a plurality of files according to user's needs and arbitrarily performing the file backup and restoration from an application, and which allows a copy process controller to monitor the occurrence of events and the occurrence of backup and restore execution requirements from an application program passed through an interface for notification, thereby performing the backup and restoration of the corresponding file.

The present application is a continuation of application Ser. No. 09/349,158, filed Jul. 8, 1999 the contents of which are incorporated herein by reference.

### BACKGROUND OF THE INVENTION

The present invention relates to a technique for doubling (backing up and restoring) a file, which is suitable for a computer system, and particularly to a file backup system which is suitable for use in the backup of a computer's file.

In a conventional file backup technique, the backup of the entire file is continuously performed by doubling or backup of a hard disk drive (HDD), for example. Therefore, a user's hardware investment is required, thus resulting in an increase in the cost of the backup.

As a result, the currently used backup technique is principally applied to large computers and work stations. However, a problem arises in that the application of the known backup technique to the recently cost-reduced personal computers will cause an increase in the cost thereof.

A technique for solving such a problem is described in, for example, Japanese Patent Laid-Open No. Hei 9-6545 (┌User File Backup System┘). This publication describes a technique for monitoring the occurrence of an error previously specified to an arbitrary file in a hard disk and backing up the corresponding file when a file access retry count subsequent to the error detection has reached a retry upper limit count specified in advance. According to this technique, the file backup can be implemented with less hardisk capacity because the object to be backed up is limited to only a file in which the file access retry count has reached the retry upper limit count specified in advance.

The prior art does not take into consideration the following points.

Since the backup is obtained only when the error retry count exceeds the previously-designated error retry upper limit count (designated value) in the prior art, the latest backup is not necessarily obtained even in the case of the presence or absence of a backup file where the need for restoring information in a file comes about before the retry count exceeds the retry upper limit count.

Namely, when the file is backed up, novelties required for backup information differ according to the contents and applications of the file to be backed up. With a view toward coping with this problem, it is necessary to perform a backup with a plurality of different frequencies, such as in the case of the acquisition of a backup with a high frequency so as to obtain the backup each time the writing of data into the file to be backed up occurs once, the acquisition of backup with a frequency lower than the former so as to obtain the backup when the writing of the data into the file is completed and the file is closed, etc.

When a plurality of files to be backed up exist, it is necessary to manage the respective files and a plurality of backup acquisition conditions in association with one another.

Further, when the number of files to be backed up increases, a time required to restore the file must be provided. It is thus difficult to manually restore data in a file used for an application in which it is necessary to frequently update the data.

When the implementation of backup acquisition and file restoration depends on a system which needs to modify an application program (hereinafter described as APP) in a computer, there may be cases where the modification of the APP for backup is difficult according to the development of the program by the user and the user's maintenance ability.

### SUMMARY OF THE INVENTION

An object of the present invention is to back up and restore a file according to user's needs independently of the APP, based on conditions inherent in a plurality of files, respectively.

Another object of the present invention is to provide a file backup system which is capable of performing file backup with less hard-disk capacity, i.e., file backup with an inexpensive capital investment of hardware according to the user's needs with efficiency and high reliability.

In order to achieve the above objects, a file backup system according to the present invention monitors data input/output operations of only an arbitrary file (designated or selected file) specified by a user and provided from an APP and the occurrence of an error at the data input/output, and copies the selected file onto a backup file or copies it from the backup file to a user selected file through the use of software independent of the APP when events (data input/output and error at that time) to be monitored occur, thereby backing up and restoring the selected file.

In accordance with the present invention in particular, a plurality of execution procedures are respectively provided for the backup and restoration. A backup sequence and a restore sequence executed individually for a plurality of selected files are respectively defined as backup and restore modes, for example. Further, a correspondence between the respective modes and the selected files is stored into the memory of the computer in table form. Thus, the file backup can be efficiently carried out according to the user's needs.

The backup mode includes a sequence of operations for performing a process or routine started for every selected file and for monitoring the close of the selected file after its updating, thereby to update the selected file and obtain backup when it is closed, and a sequence of operations for performing a process or routine for monitoring an opportunity at which the writing of data into the selected file occurs, thereby obtaining backup when the writing of the data into the selected file occurs.

Further, the file restore mode includes a sequence of operations started for each selected file when a data input/output failure occurs in the selected file and for detecting the occurrence of the failure in the selected file at the time of data input/output, thereby to restore the file when a data input/output failure occurs in the selected file, a sequence of operations for restoring a file by manual operation of a user at an arbitrary point in time, and a sequence of operations for restoring a file when required from an arbitrary APP using the selected file.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a block diagram showing one embodiment of the present invention;

FIG. 2 is a diagram illustrating configurations of a backup mode and a restore mode in a configuration table employed in the present embodiment;

FIG. 3 is an explanatory diagram showing the difference between copy operations done in every backup mode;

FIG. 4 is a flowchart for describing an example of a main processing operation of a table loader employed in the present embodiment;

FIG. 5 is a flowchart for describing an example of an input processing operation of the table loader employed in the present embodiment;

FIG. 6 is an explanatory diagram showing an configurational example of the configuration table employed in the present embodiment;

FIG. 7 is a flowchart for describing an example of a processing operation of a table reader employed in the present embodiment;

FIG. 8 is a flowchart for describing an example of a processing operation of a copy process controller employed in the present embodiment;

FIG. 9 is a flowchart for describing an example of a processing operation of a copy processor employed in the present embodiment;

FIG. 10 is a flowchart for describing an example of a file I/O monitor routine of the copy process controller employed in the present embodiment;

FIG. 11 is a flowchart for describing an example of a running time monitor routine executed in conjunction with the execution of the copy processor employed in the present embodiment;

FIG. 12 is a flowchart for describing an example of a processing operation of an interface for notification, which is employed in the present embodiment;

FIG. 13 is a diagram showing an example of information transferred between an APP and the interface for notification, both employed in the present embodiment;

FIG. 14 is a flowchart for describing an example of a file I/O terminate monitor routine started by the copy process controller employed in the present embodiment;

FIG. 15 is a flowchart for describing an example of a notification monitor routine started by the copy process controller employed in the present embodiment;

FIG. 16 is a flowchart for describing another example of a processing operation of the interface for notification, which is employed in the present embodiment; and

FIG. 17 is a flowchart for describing an example of an error monitor routine started by the copy process controller employed in the present embodiment.

### DESCRIPTION OF THE PREFERRED EMBODIMENT

A preferred embodiment of the present invention will hereinafter be described.

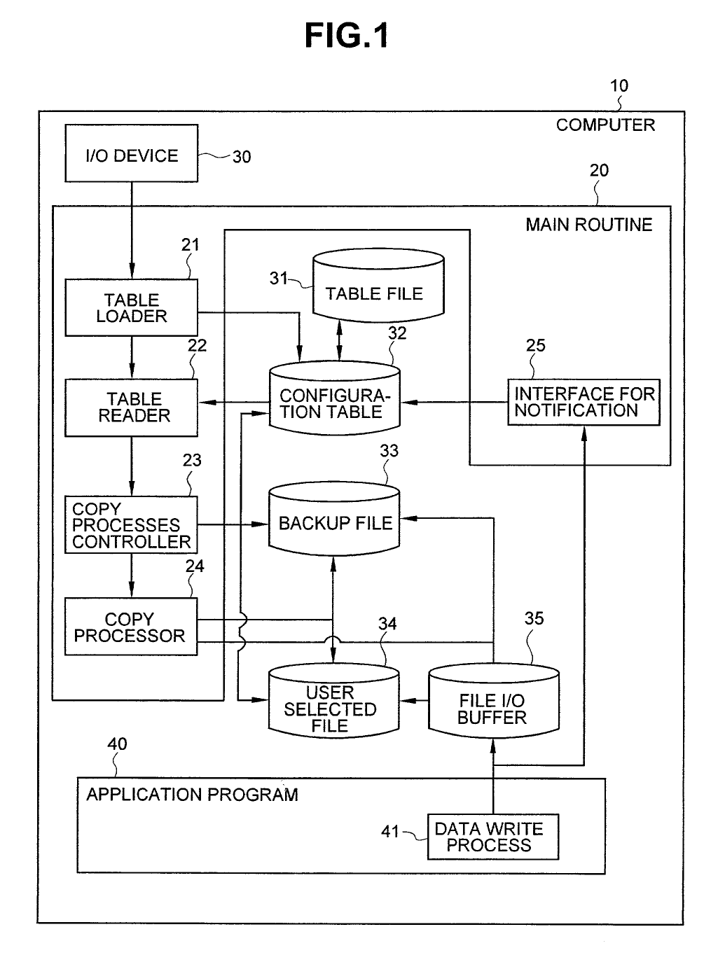

FIG. 1 is a block diagram showing one embodiment of a user file backup system according to the present invention.

The user file backup system according to the present embodiment is constructed within a computer 10, such as a personal computer. The computer 10 comprises a main routine 20 for performing processes such as file backup, etc. in a stored program system through the use of a CPU (Central Processing Unit), an I/O device 30 comprised of a display and a keyboard or the like, a table file 31, a backup file 33, a user selected file 34 to be backed up, a configuration table 32 on a main memory, and a file I/O buffer 35 all placed in a hard disk drive (HDD), and an APP 40 having a data write process 41 for reading data into the user selected file 34.

The main routine 20 comprises a table loader 21 for controlling the starting and stopping of the main routine 20, a table reader 22 for referring to the contents recorded in the configuration table 32, a copy process controller 23 for monitoring data updating to the user selected file 34 and the occurrence of an error in the user selected file 34 and the occurrence of a requirement notification from the APP 40 according to the contents of the configuration table 32 for starting a copy process where a backup execution condition is met, a copy processor 24 started up by the copy process controller 23 and for actually executing the backup of a file, and an interface 25 for notification for accepting a file backup requirement issued from the APP 40.

Owing to such a construction, the user file backup system (hereinafter described as ┌present system┘) according to the present embodiment performs file backup in the following manner.

When the computer 10 is started up or a user request or requirement is made from the I/O device 30, the table loader 21 of the present system performs the function of receiving the name of a user selected file, the name of a backup file, a backup mode and a restore mode, and the input of other information from a user, all given as information for backing up the file, and performs expansion of user-entered information sent from the table file 31 to the configuration table 32 and the startup of the table reader 22.

The table reader 22 refers to the user-entered information recorded in the configuration table 32 to start up the copy process controller 23 and sends the table contents referred to thereby to the copy process controller 23.

The copy process controller 23 monitors the occurrence of updating of the user selected file 34 and the occurrence of an error therein and the occurrence of a file backup requirement from the APP 40 from the notified contents of the table according to the backup mode and the restore mode. Further, the copy process controller 23 starts up the copy processor 24 when the monitored items coincide with the backup and restore execution conditions, and sends the table contents to the copy processor 24 as information for executing a backup.

The started copy processor 24 sends a copy of a file between the user selected file 34 and the backup file 33 and sends a copy of the data from the file I/O buffer 35 to the backup file 33 on the basis of the information received from the copy process controller 23.

When it is desired to perform backup and restore operations according to a request issued from the APP 40, the data write process 41 invokes the interface 25 for notification and passes a user selected file name, and a header address and the record length of a data record with respect to the user selected file to the interface 25. The interface 25 records the occurrence of the request and the header address and record length of the data record in the configuration table 32.

The details of the contents, structures and processing of respective components of such a user file backup system will next be described.

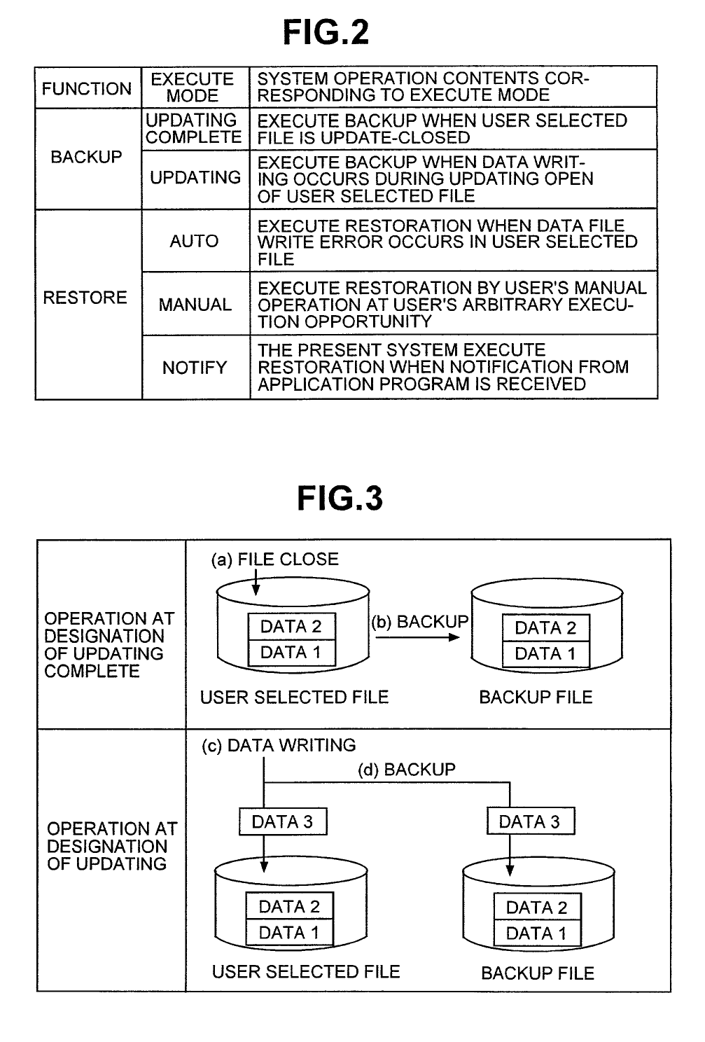

A description will first be made of the backup mode and restore mode executed by the present system with reference to FIG. 2.

FIG. 2 is an explanatory view showing the configurations of the backup mode and restore mode in the configuration table shown in FIG. 1.

The present embodiment shows the correspondence of the operation of the present system relative to the backup mode and the restore mode.

Namely, the backup mode provides the two operations of ┌Updating Complete┘ and ┌Updating┘. When the ┌Updating Complete┘ operation is specified, the present system performs backup when the user selected file 34 shown in FIG. 1 is closed after updating. When the ┌Updating┘ operation is designated, the present system executes backup when data writing occurs while the user selected file 34 is open under update authority thereof.

The restore mode has three types of operation including ┌Auto┘, ┌Manual┘ and ┌Notify┘. When the ┌Auto┘ operation is specified, restoration is executed when an error occurs upon the input and output of data to and from the user selected file 34. When the ┌Manual┘ is specified, the user manually executes restoration from the backup file 34. When the ┌Notify┘ operation is designated, restoration is executed when notification is issued from the APP 40 using the user selected file 34.

The difference between the backup operations at the time when the Updating Complete operation is specified and the Updating operation is specified, will next be explained with reference to FIG. 3.

FIG. 3 is a diagram showing the difference between copy operations in each of the backup modes.

The difference between the backup operations at the time when the Updating Complete operation is specified and the Updating operation is specified, is particularly shown in FIG. 3.

When the Updating Complete operation is specified, data backup is done by copying the entire user selected file 34 on the backup file 33 by overwriting (b) when the updated close of the user selected file 34 is produced (a).

On the other hand, when the Updating operation is specified, the same data is backed up by being additionally copied on the backup file 33 (d) each time data writing occurs while the user selected file 34 is being updated (c).

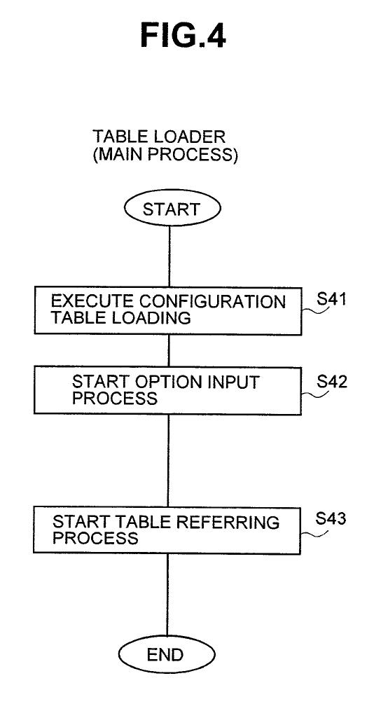

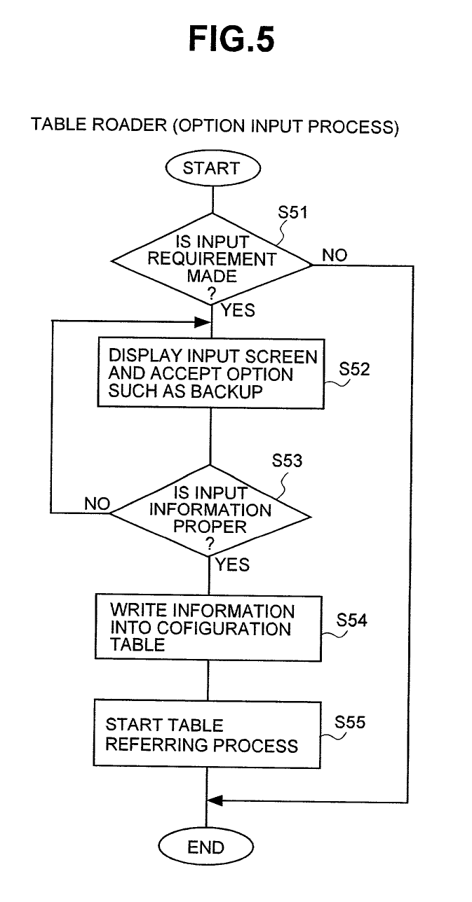

The table loader 21 for controlling the start and stop of the main routine 20 shown in FIG. 1 and for receiving or accepting a user input therein will next be described with reference to FIGS. 4 and 5.

FIG. 4 is a flowchart showing an example of a main processing operation of the table loader shown in FIG. 1.

FIG. 5 is a flowchart showing an example of an input processing operation of the table loader shown in FIG. 1.

The processing used in the present example is first started in the main routine 20 upon startup of the computer 10 shown in FIG. 1, or according to the user requirement from the I/O device 30, and consists of a main process and an input process for accepting the user input. The main process and the input process will be explained with reference to FIGS. 4 and 5, respectively.

The main process is a routine for loading the configuration table for storing information inputted from the user therein into a memory and for starting a table referring process for referring to the contents of the table.

After the starting of the main process, the configuration table is first loaded into the memory in FIG. 4 (Step S41). An option input process for accepting the user input is next started (Step S42). Thereafter, the table referring process is started to refer to the contents of the table (Step S43), whereby the main process is terminated.

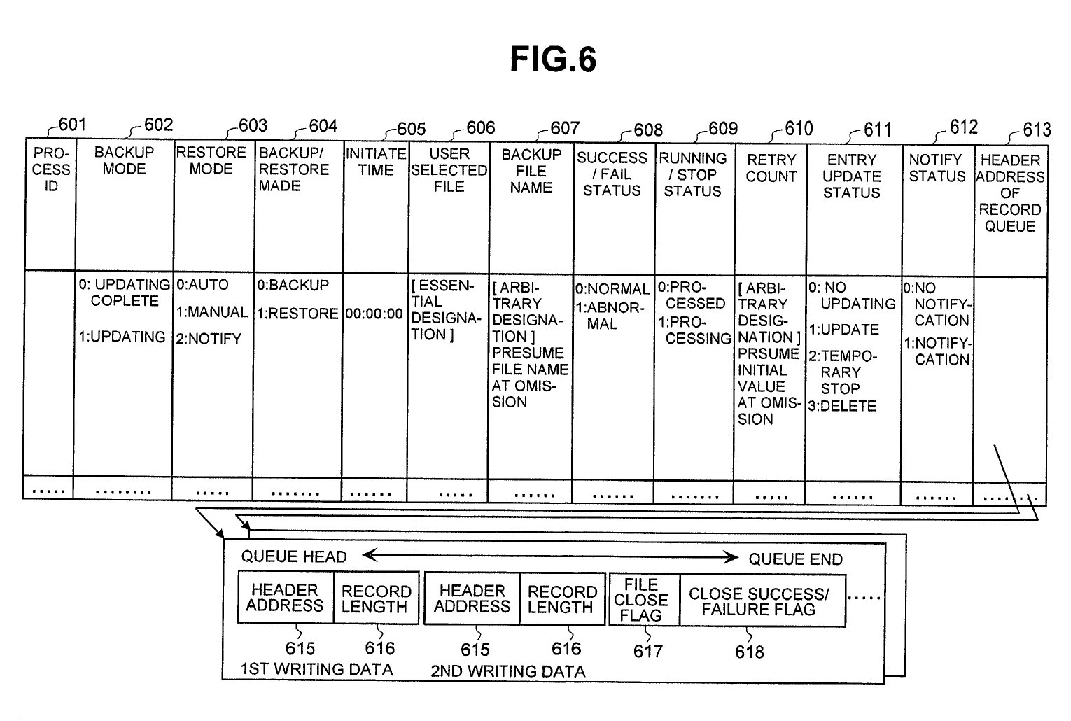

The input process for checking the contents of information inputted from the user and for writing the information into the configuration table 32 shown in FIG. 1 will next be explained with reference to FIG. 5. Incidentally, the contents of the information inputted from the user are shown in FIG. 6. The information in FIG. 6 directly inputted by the user will be explained relative to respective processes to be described later with reference to FIG. 6.

It is determined in FIG. 5 whether a user input request for setting options, such as backup, etc., is made after the starting of the present process (Step S51). If the answer is found to be NO in Step S51, then the input process is terminated. If the answer is found to be YES in Step S51, then an input screen is displayed on the I/O device 30 (Step S52).

In the input screen, inputs such as a backup mode 602, a restore mode 603, a user selected file name 606, a backup file name 607 and a retry count 610, etc. are accepted as user directly-entered information.

The retry count 610 shown in FIG. 6 is used to specify how many times retry should be done at a maximum where the backup process and restoring process are not terminated normally. The backup mode 602, the restore mode 603 and the user selected file name 606 are inevitably inputted. Further, the user input related to the backup file name 607 and the retry count 610 may be omitted. In this case, the present system presumes the file name and the count.

In FIG. 5, the table reader 21 thereafter checks whether or not the input information indicative of the conditions such as backup, etc. is proper (Step S53). If the information is found to be improper in Step S53, then the input process is returned to the input screen display in Step S52, where the user is urged to make a re-input. If the information is found to be proper in Step S53, then the information is written into the configuration table 32 (Step S54).

Owing to the execution of the user input, any of a new registration, updating and deletion of the user selected file name is performed and hence the content of the table is regarded as being changed. The table reader 22 shown in FIG. 1 is started to refer to the updated contents of the table (Step S55).

When the already-registered contents has been updated, only the backup file name and the retry count are permitted as objects to be updated, and a change in the user selected file name is treated as a new registration.

The contents of the configuration table 32 for managing the correspondence between the user selected file 34 indicative of such a file to be backed up to the backup mode and restore mode executed for the user selected file 34 will be explained with reference to FIG. 6.

FIG. 6 shows an example of the configuration of the configuration table employed in the present embodiment.

The configuration table 32 is constructed so as to hold, as one entry, information in which objects to be backed up and options for backup are associated with one another.

Item-by-item functions will successively be described below.

First, the horizontal axis of the configuration table is made up of a ┌Process-ID┘ 601, a ┌Backup Mode┘ 602, a ┌Restore Mode┘ 603, a ┌Backup/Restore Mode┘ 604, a ┌Initiate Time┘ 605, a ┌User Selected File Name 606, a ┌Backup File Name┘ 607, a ┌Success/Fail Status flag┘ 608, a ┌Running/Stop Status flag┘ 609, a ┌Retry Count┘ 610, a ┌Entry Update Status┘ 611, a ┌Notify Status┘ 612, and respective items of a ┌Record Queue┘ 613.

Now, the ┌Process-ID┘ 601 is used to specify the process of the copy processor 24 shown in FIG. 1, which actually performs copying. The ┌Backup/Restore Mode┘ 604 is used to determine which of the backup and restore operations is done when the copy processor 24 is not normally terminated. Further, the ┌Initiate Time┘ 605 is used to monitor, based on the processing start time of the copy processor 24, whether a time interval improperly long for processing is required.

The ┌Success/Fail Status flag┘ 608 is used to determine whether the copy processor 24 is normally terminated. The ┌Running/Stop Status flag┘ is used to determine whether the occurrence of updating and an error in the user selected file 34 is in a monitored state. The ┌Retry Count┘ 610 is used to define how many times retry should be done at maximum when the copy processor 24 ends in failure.

Further, the ┌Entry Update Status┘ 611 is used to indicate or define the form of a change in registered entry where the registered entry is changed according to the user input. The ┌Notify Status┘ 612 is used to indicate whether or not a requirement issued from the APP is notified.

The ┌Record Queue┘ 613 defined as the final item of the configuration table 32 is used to store therein position information for each item of data in the file I/O buffer 35, the occurrence of a closing of the user selected file 34 after its renewal, and the header address of a queue area for storing the result of its occurrence therein with a view toward backing up the data written into the user selected file 34 for each data item where the Updating is specified to the ┌Backup Mode┘ 602.

The ┌Record Queue┘ 613 holds therein two types of information, including a header address and a record length of data held in the memory, to obtain the data written into the user selected file one by one. The presence or absence of closing of the user selected file 34 after its updating, done after the data writing, and the result thereof are stored in FIFO queue form in the order in which the data writing and the file closing after the updating of the file are developed in two formats in the form of a file close flag 617 and a close success/failure flag 618. Incidentally, the queue area is generated in advance for each entry in which the backup mode is specified as Updating. The so-generated queue areas are associated with each other by storing header addresses of the queue areas in the record queue header addresses corresponding to the final items of each of the individual entries.

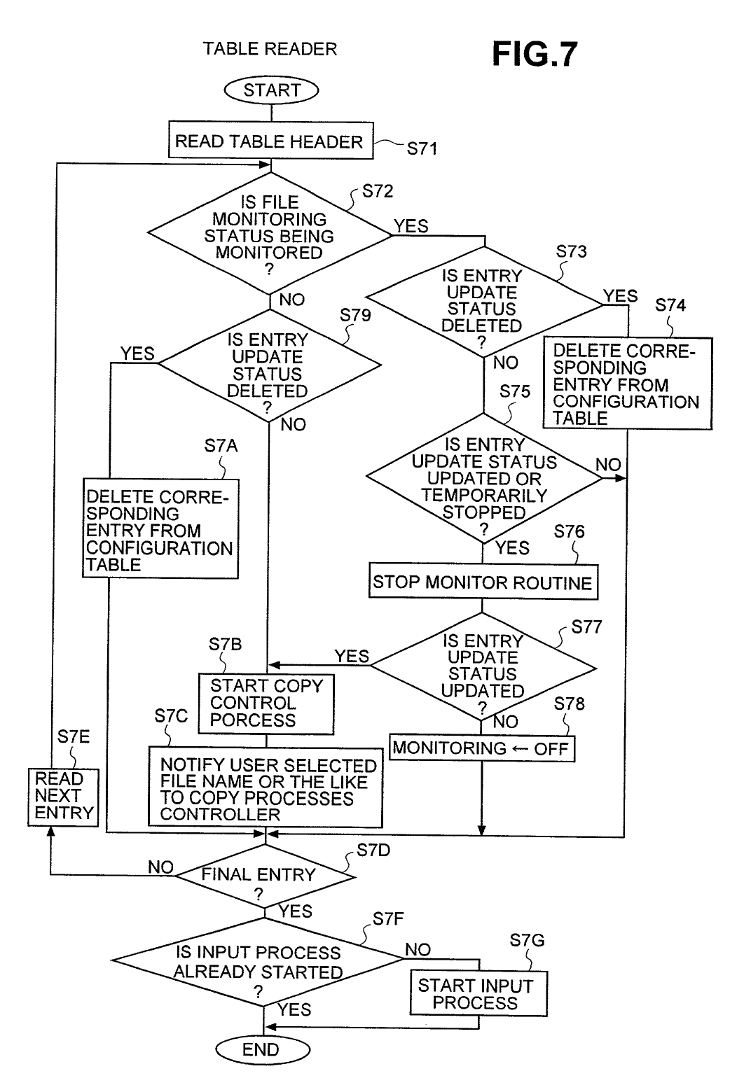

The table reader 22 shown in FIG. 1, which refers to the contents of the configuration table 32 having such a construction, will next be explained with reference to FIG. 7.

FIG. 7 is a flowchart showing an example of a processing operation to be executed by the table reader shown in FIG. 1.

The table reader 22 shown in FIG. 1, which performs the processing of the present embodiment, is started upon startup of the present system and the occurrence of a user input.

After the starting of the present process, the table reader 22, first refers to the header line of the configuration table 32 shown in FIG. 1 (Step S71) and determines whether a file monitoring status of the entry referred to by the table reader 22 is being monitored (Step S72).

If the answer is found to be YES in Step S72, then the table reader 22 determines whether the entry update status is deleted (Step S73). If the answer is found to be YES in Step S73, then the table reader 22 judges that a request for deleting the entry has been made from the user as instructions for canceling backup. Thus, the corresponding entry is deleted from the configuration table 32 (Step S74) and the table processor 22 proceeds to the determination of the final entry in Step S7D.

When the entry update status is regarded as not being deleted in Step S73, the table reader 22 determines whether the entry update status is either that of updating or a temporary stop (Step S75). If the answer is found to be NO in Step S75, the user selected file 34 is determined as having no change in the monitored entry at present, and the table reader 22 proceeds to the decision of S7D as to the final entry. When the entry update status is found to be either that of updating or temporary stop, the table reader 22 stops a subprocess corresponding to a copy control process, based on the process-ID of the entry (Step S76).

It is thereafter determined whether the entry update status indicates an updating (Step S77). If the answer is found to be YES in Step S77, then the table reader 22 proceeds to a copy control process startup of Step S7B. When the entry update status is determined as being not that of updating, the table reader 22 determines a user requirement as being that of a temporary stop of an entry, and the monitoring status of the entry is set as unmonitored, followed by proceeding to the final entry decision of Step S7D.

When the entry referred to by the table reader 22 is determined as being not monitored in Step S72, the table reader 22 determines whether a deletion request is being made to the non-monitored entry (Step S79). When the entry update status is found to be deletion, the table reader 22 deletes the corresponding entry and proceeds to the final entry determination of Step S7D.

When the entry update status is found not to be deletion, the table reader 22 determines the entry as being newly registered, and starts up the copy process controller 23 to start the supervision of a user selected file (Step S7B). Thereafter, the table reader 22 sends the user selected file name, backup file name, backup mode and restore mode specified to the configuration table 32 to the started copy process controller 23 (Step S7C).

It is thereafter determined whether the entry referred to by the table reader 22 corresponds to the final entry in the configuration table 32 (Step S7D). If the answer is found not to be the final entry, then the table reader 22 refers to the next entry and proceeds to a decision in Step S86 as to whether the restore mode is manual. If the answer is found to be the final entry in Step S7D, then the table reader 22 determines whether the input process of the table loader 21 has been started (Step S7F). If the answer is found to be NO in S7F, then the input process is started (Step S7G). When the input process is already started, the present process is terminated.

A description will next be made of the copy process controller 23 shown in FIG. 1, which accepts the contents that the table reader 22 refers to in this way and monitors the occurrence of events coincident with backup and restore execution conditions.

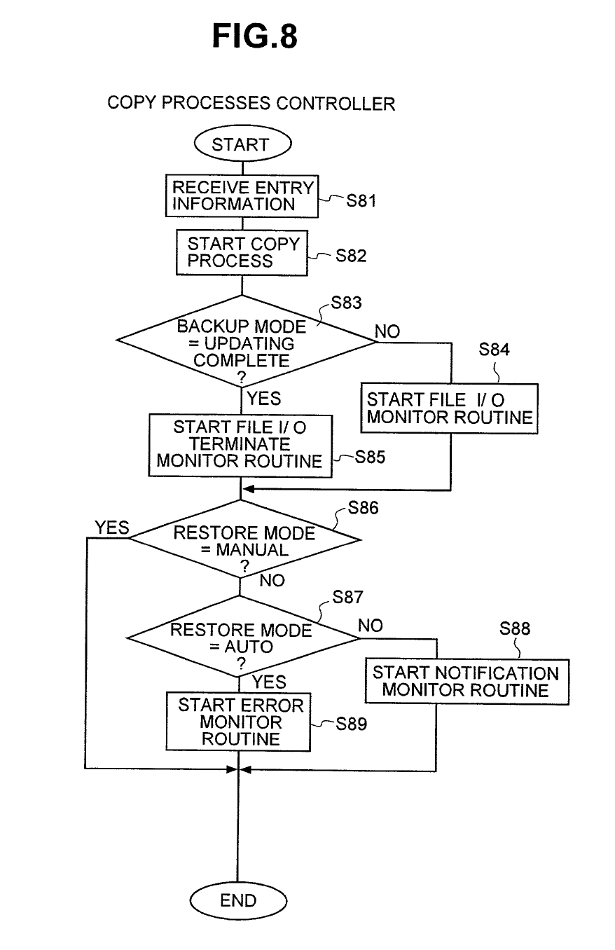

FIG. 8 is a flowchart showing an example of a processing operation of the copy process controller shown in FIG. 1.

After the starting of the present process, the copy process controller 23 receives information about a user selected file name, a backup file name, a backup mode and a restore mode from the table reader 22 shown in FIG. 1 corresponding to the origin of startup or a startup source (Step S81).

The copy process controller 23 starts up the copy processor 24 for performing actual file copying, based on the received information to obtain initial backup to a user selected file, thereby creating a backup file 33 (Step S82).

Next, the copy process controller 23 determines whether the notified backup mode indicates that updating is complete (Step S83).

If the backup mode indicates updating, then the copy process controller 23 monitors the writing of data record information from the interface 25 for notification to the configuration table 32. When the writing is monitored, the copy process controller 23 starts a file I/O monitor routine for starting up the copy processor 24 and proceeds to the decision of Step S86 as to whether the restore mode is manual.

If the backup mode is found to be updating complete in Step S83, then the copy process controller 23 monitors the updating completion of the user selected file 34. When the updating completion is made, the copy process controller 23 starts a file I/O terminate monitor routine for starting up the copy processor 24 (Step S85). It is next determined whether the restore mode of the notified entry is manual (Step S86). If the answer is found to be YES in Step S86, then the present process is terminated because it is unnecessary to start up the copy processor 24 for restore execution.

When the restore mode is found not to be manual, the copy process controller 23 determines whether the mode is auto (Step S87). If the answer is found to be NO in Step S87, then the copy process controller 23 determines that the restore mode is notification, and monitors the occurrence of notification from the APP. When the notification is issued from the APP, the copy process controller 23 starts a notification monitor routine for starting up the copy processor 24 (Step S88). If the restore mode is found to be auto in Step S87, then the copy process controller 23 monitors the occurrence of a data input/output error or file write error of the user selected file 34. When the error occurs, the copy process controller 23 starts an error monitor routine for starting up the copy processor 24 for a restore execution (Step S89).

Thus, the copy process controller 23 shown in FIG. 1 is started up from within the table reader 22 in the proportions of once to one entry lying in the configuration ,table 32 and starts the respective monitor routines according to the backup mode and the restore mode of the corresponding entry.

A description will next be made of the copy processor 24 shown in FIG. 1, which is started up from within the copy process controller 23 in this way and performs copying for actual backup and restoration.

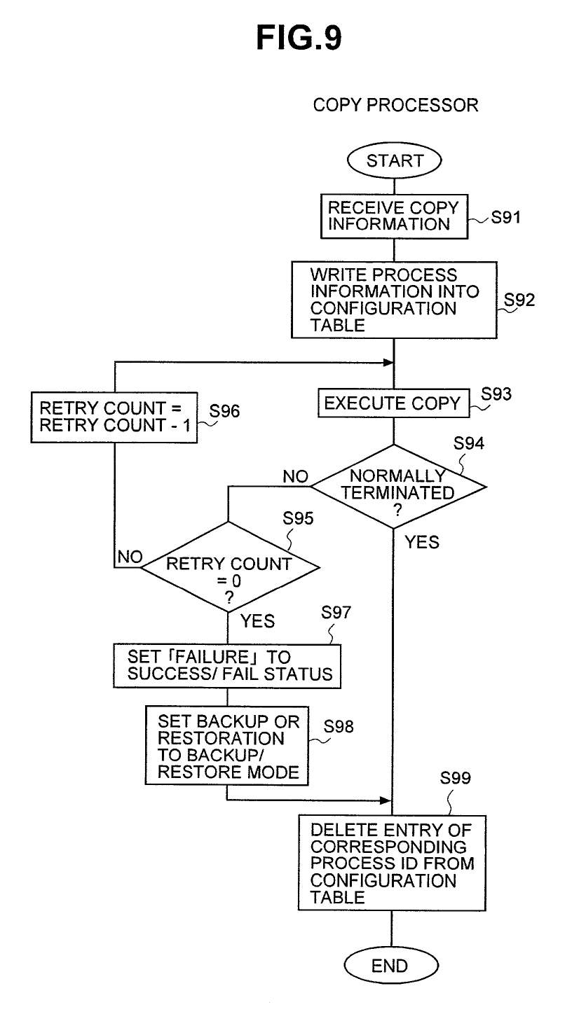

FIG. 9 is a flowchart showing an example of a processing operation of the copy processor shown in FIG. 1.

After the present process has been started, the copy processor 24 receives a file name of a copy origin or the place of copy origin data, a file name of a copy destination and a retry count as information for determining a copy operation from the copy process controller 23 shown in FIG. 1 (Step S91).

Further, the copy processor 24 writes a self process-ID and the present time used as a copy start time into corresponding items of an entry in the configuration table 32 as information for coping with an error produced upon copy execution (Step S92).

Thereafter, the copy processor 24 executes copying based on the information received in Step S91 (Step S93). It is determined whether the copying is normally terminated (Step S94). If the answer is found to be NO in Step S94, then the copy processor 24 determines whether the retry count reaches an upper limit (Step S95).

If the answer is found to be NO in Step S95, then the copy processor 24 subtracts one from the retry count (Step S96) and proceeds to the copy execution of Step S93 to execute the copying again. When the answer is found to be YES in Step S95, the copy processor 24 sets a malfunction or failure to a success/fail status flag of the corresponding entry of the configuration table 32 (Step S97). Further, the copy processor 24 sets backup or restoration to a backup/restore mode in order to record in which of the backup and restoration operations the failure occurs (Step S98) and proceeds to a process of Step S99 for deleting the entry of the corresponding process ID from the configuration table.

A process ID of a copy execution process and a process start time used as a copy start time, which is taken as a process start time, are written into corresponding items of the entry in the configuration table 32 as information for determining a time interval spent abnormally until the completion of the copy execution as an error (Step S92).

Thus, the copy processor 24 executes the backup and restoration procedures according to the contents of the information sent from the copy process controller 23 corresponding to the start source.

A description will next be made of the details of the file I/O monitor routine, i.e., Step S84 in FIG. 8 started from within the copy process controller 23 and for monitoring the writing of the location of a data record into a queue area pointed to from the configuration table 32 where the backup mode is updating.

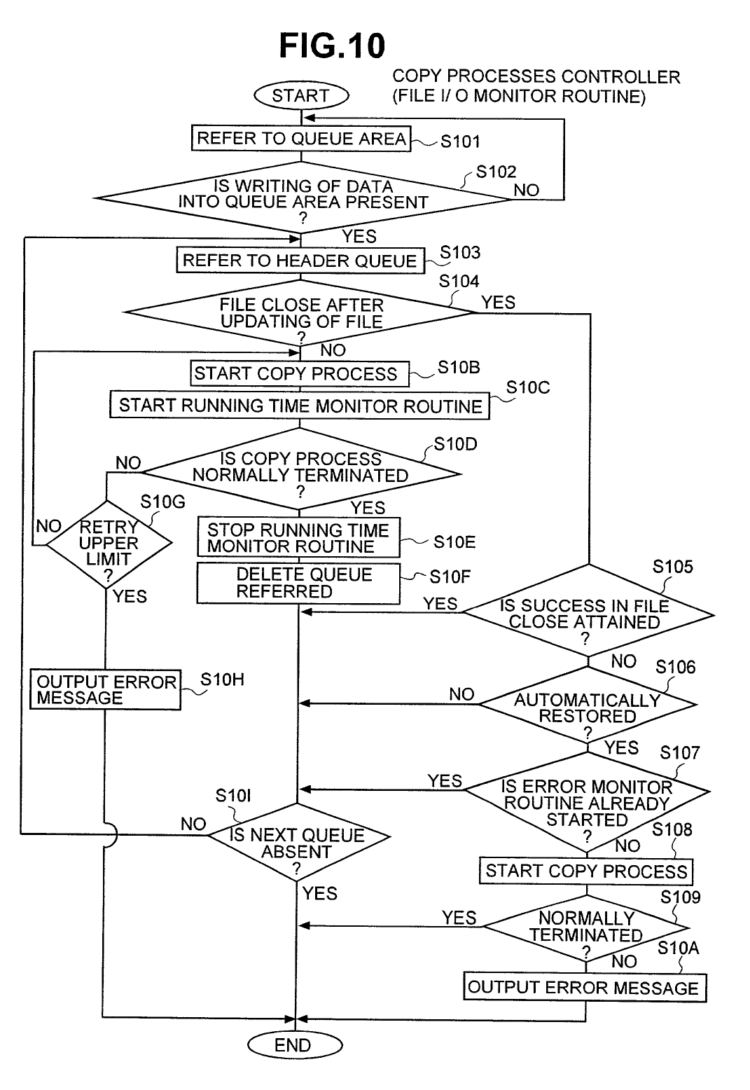

FIG. 10 is a flowchart showing an example of a file I/O monitor routine of the copy process controller 23 shown in FIG. 1.

After the starting of the present routine, the copy process controller 23 first refers to a queue area of a corresponding entry on the configuration table 32 shown in FIG. 6 (Step S101).

The copy process controller 23 determines the presence or absence of the writing of data into the queue area (Step S102). If the answer is found to be NO in Step S102, the copy process controller 23 proceeds to the queue area reference of Step S101 to continue referring to the queue area and monitor the occurrence of the writing. If the answer is found to be YES in Step S102, then the copy process controller 23 refers to the contents of a header queue (Step S103).

Further, the copy process controller 23 determines whether the contents of the queue corresponds to file closing after the updating of the user selected file 34 (Step S104). If the answer is found to be NO in Step S104, then the copy process controller 23 starts up the copy processor 24 and sends the contents of the queue thereto (Step S10B). Further, the copy process controller 23 starts running time monitor routine for monitoring a running time of the copy processor 24 (Step S10C).

Thereafter, the copy process controller 23 determines based on the success/fail status flag in the configuration table 32 whether the copy process is normally terminated (Step S10D).

If the answer is found to be YES in Step S10D, then the copy process controller 23 stops the running time monitor routine (Step S10E) and deletes the contents of the leading queue referred to thereby from the queue area (Step S10F). Further, the copy process controller 23 determines whether the next queue exists (S101). If it is determined that the next queue does not exist, then the present routine is terminated.

If the answer is found to be YES in Step S101, then the copy process controller 23 proceeds to the header queue reference of Step S103 for the purpose of referring to the next queue.

Further, when it is determined in Step S10D that the copy processor 24 is not normally terminated, the copy process controller 23 determines whether the retry count has reached the upper limit thereof (Step S10G). If the answer is found to be NO in Step S10G, then the copy process controller 23 starts up the copy processor 24 again to continuously perform the routine and proceeds to the copy process startup of Step S10B to notify the contents of a queue referred to thereby at present to the copy processor 24. When the retry count has reached the upper limit, the copy process controller 23 determines that a fatal failure, which makes it impossible to perform data copying, has occurred in a file system. Thus, an error message is outputted from the I/O device 30 (Step S10H) and the present routine is terminated.

If the answer is found to be YES in Step S104, then the copy process controller 23 determines by reference to a close success/failure status flag (618) of the corresponding queue whether the file closing has been successful (Step S105). If the answer is found to be YES in Step S105, then the copy process controller 23 proceeds to the decision of Step S101 as to whether the next queue exists. If the answer is found to be NO in Step S101, it is then determined whether the restore mode 603 specified to the corresponding entry is automatic restoration (Step S106). If the answer is found to be NO in Step S106, then the copy process controller 23 proceeds to the decision of Step S101 as to whether the next queue exists. If the answer is found to be YES in Step S106, then the copy process controller 23 determines whether the error monitor routine started in Step S89 of the copy process controller 23 is started (Step S107).

If the answer is found to be YES in Step S107, then the copy process controller 23 proceeds to the decision of Step S101. If the answer is found to be NO in Step S107, then the copy process controller 23 determines that the file closing after the updating of the user selected file 34 has failed and that it is necessary to restore data written between the final write opening of the user selected file 34 and the file closing thereof. Thereafter, the copy process controller 23 starts up the copy processor 24 to specify the backup file 33 to a copy source file and specify the user selected file 34 to a copy destination file, thereby allowing the copy processor 24 to perform copying (Step S108).

Thereafter, the copy process controller 23 determines whether the operation the copy processor 24 is normally terminated (Step S109). If the answer is found to be YES in Step S109, then the copy process controller 23 terminates the present file I/O monitor routine. If the answer is found to be NO in Step S109, then the copy process controller 23 determines that a fatal failure has occurred in the file system, and thereby outputs an error message through the I/O device 30 (Step S10A) and terminates the present routine.

A description will next be made of the running time monitor routine for monitoring a required operating time of the copy processor 24 and preventing the waste of an improper long processing time, i.e., the details of the process of Step S10C in FIG. 10.

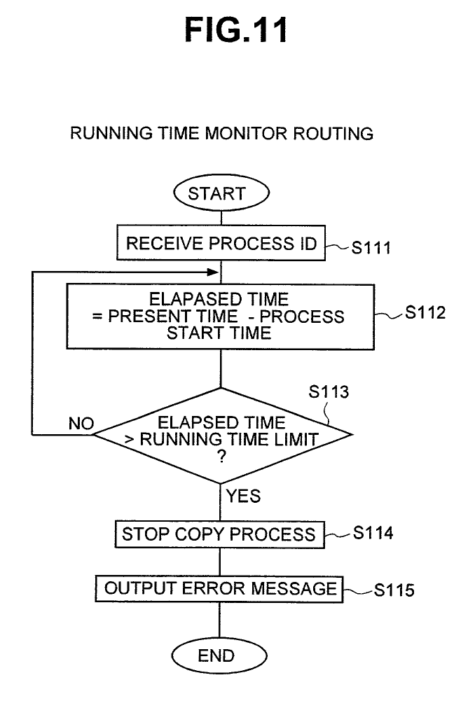

FIG. 11 is a flowchart for describing an example of a running time monitor routine executed in with the operation of the copy processor shown in FIG. 1.

The present routine is started in pair with the process of the copy processor 24 shown in FIG. 1 and corresponds to a process selectively started from the file I/O monitor routine, file I/O terminate monitor routine, notification monitor routine and error monitor routine of the copy process controller 23.

After the starting of the present routine, the copy process controller 23 receives therein a process-ID of the copy processor 24 started from the process of the startup source (Step S111).

When the copy processor 24 is started up according to the received process-ID, the processing start time written in the configuration table 32 is subtracted from the present time (Step S112). It is determined whether the subtracted time exceeds the running time limit specified in advance (Step S113).

If the answer is found to be NO from the result of the determination in Step S113, then the operation of the copy process controller 23 returns to Step S112 where the elapsed time is continuously calculated. If the answer is found to be YES in Step S113, then the copy process controller 23 stops the copy processor 24 (Step S114). Thereafter, the copy process controller 23 outputs an error message through the I/O device (Step S115) and terminates the present routine.

Incidentally, the present routine is forcefully stopped from the process of the start source when the copy processor 24 to be monitored is terminated normally or abnormally.

A description will next be made of the operation of the interface 25 for notification at the time that updating is specified to the backup mode in the configuration table 32 shown in FIG. 1.

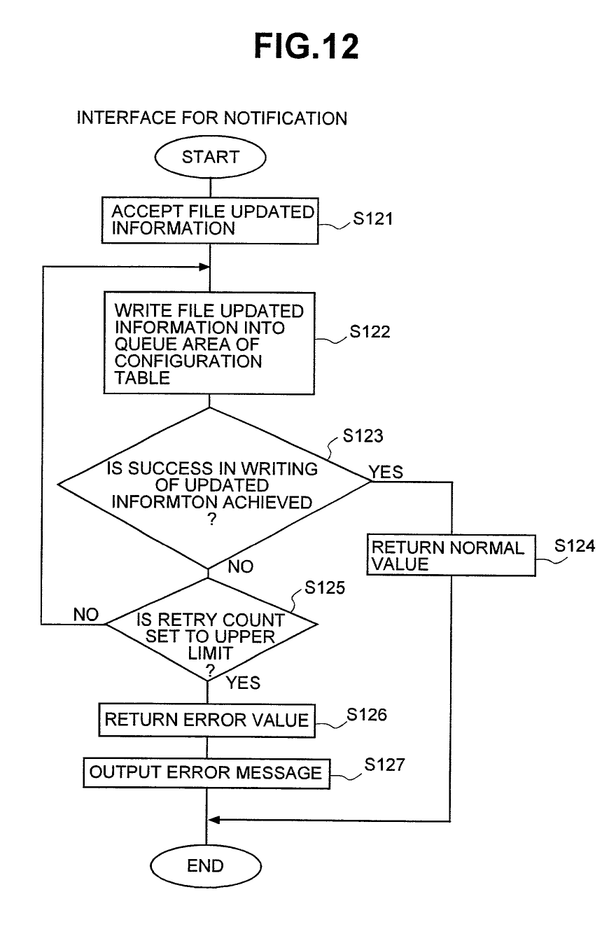

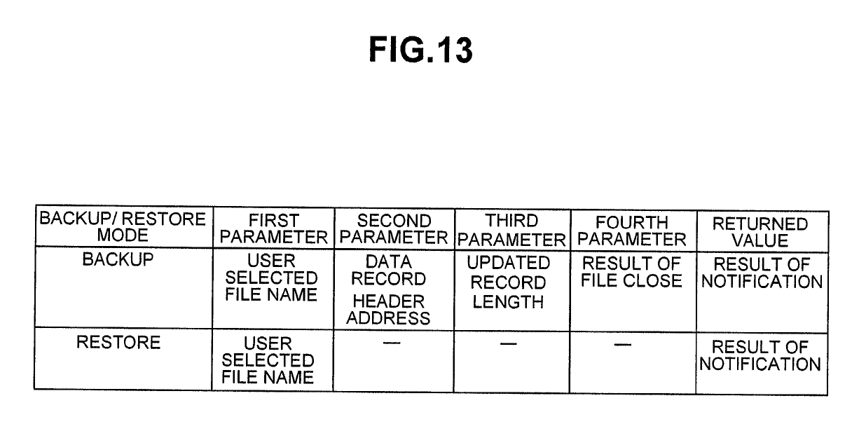

FIG. 12 is a flowchart showing an example of the processing operation of the interface shown in FIG. 1. FIG. 13 is an explanatory view showing an example of information transferred between the APP and the interface for notification shown in FIG. 1.

The process of the present interface 25 is used to invoke data to be written into the user selected file 34 from the data write process 41 for the user selected file 34, of the APP 40 when updating is specified to the backup mode of the configuration table 32 shown in FIG. 1, thereby to send the data to the main routine 20.

An actual calling opportunity or timing may be called after the user selected file 34 in the data write process 41 is opened.

Simultaneously with the calling of the process of the present interface 25, the interface 25 accepts a user selected file name, and a header address and a record length of the data written into the file I/O buffer 35, or the result of closing of the user selected file 34 in the formats shown in FIG. 13 as parameters from the data write process 41 (Step S121).

The interface 25 writes the received information into a queue area corresponding to the corresponding entry in the configuration table 32 (Step S122). The interface 25 determines whether the writing has succeeded (Step S123). If the answer is found to be YES in Step S123, then the interface 25 returns the normal value to the data write process 41 corresponding to the call source (Step S124) and terminates the process.

If the answer is found to be NO in Step S123, then the interface 25 determines whether a retry count has reached the upper limit of the retry count (Step S125). If the answer is found to be NO in Step S125, then the interface 25 returns to the queue area writing, where it continues to write the information.

If the answer is found to be YES in Step S125, then the interface 25 returns an error value to the data write process 41 used as the call source (Step S126). Further, the interface 25 determines that a fatal failure has been developed upon writing the information into the queue area, and thereby outputs an error message through the I/O device 30 (Step S127). Thereafter, the interface 25 terminates the present process.

Incidentally, the handling of the error value returned to the data write process 41 in Step S126 is arbitrary according to the APP 40 and the process of the data write process 41. Further, the retry count may be designated from the call source as a parameter. Upon the omission thereof, the interface 25 presupposes the initial value at the interface side.

A description will next be made of the file I/O terminate monitor routine of the copy process controller 23, which is started in Step S85 in FIG. 8.

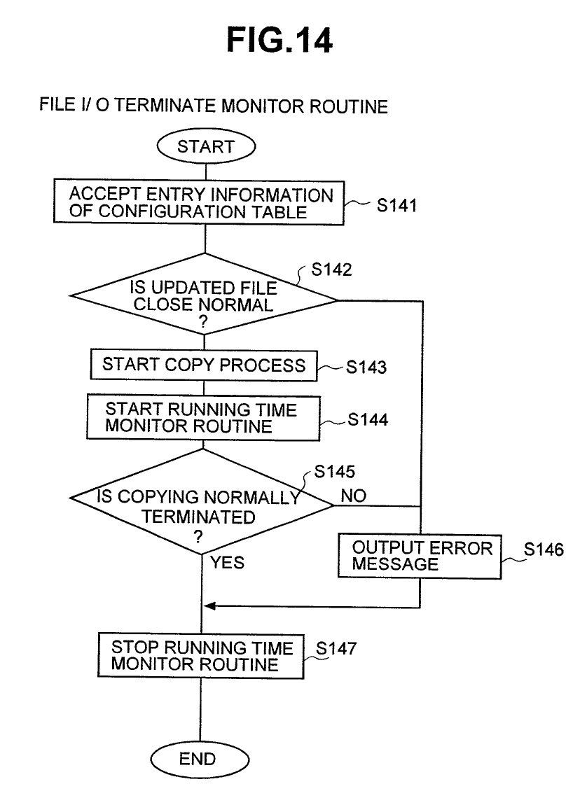

FIG. 14 is a flowchart showing an example of a file I/O terminate monitor routine operation started by the copy process controller shown in FIG. 1.

The present routine is used to monitor the update closing of the user selected file 34 when the backup mode is given as updating complete and to start up the copy processor 24 upon generation of the update closing, thereby to allow the copy processor 24 to execute a backup.

After the starting of the present routine, the copy process controller 23 first receives information about the corresponding entry on the configuration table 32 (Step S141) and starts to monitor an input/output event relative to the user selected file 34.

When the success in the updated file closing is detected from the event while being monitored (Step S142), the copy process controller 23 starts up the copy processor 24 (Step S143) and sends a user selected file name and a backup file name from the received entry information to the copy processor 24.

Further, the copy process controller 23 starts the running time monitor routine of the copy processor 24 (Step S144) and thereafter determines whether the operation of the copy processor 24 is normally terminated (Step S145). If the answer is found to be YES in Step S145, then the copy process controller 23 stops the running time monitor routine (Step S147) and terminates the present routine.

If the answer is found to be NO in Step S142 and the answer is found to be NO in Step S145, then the copy process controller 23 outputs an error message through the I/O device 30 in Step S146 and proceeds to a running time monitor stop in Step S147.

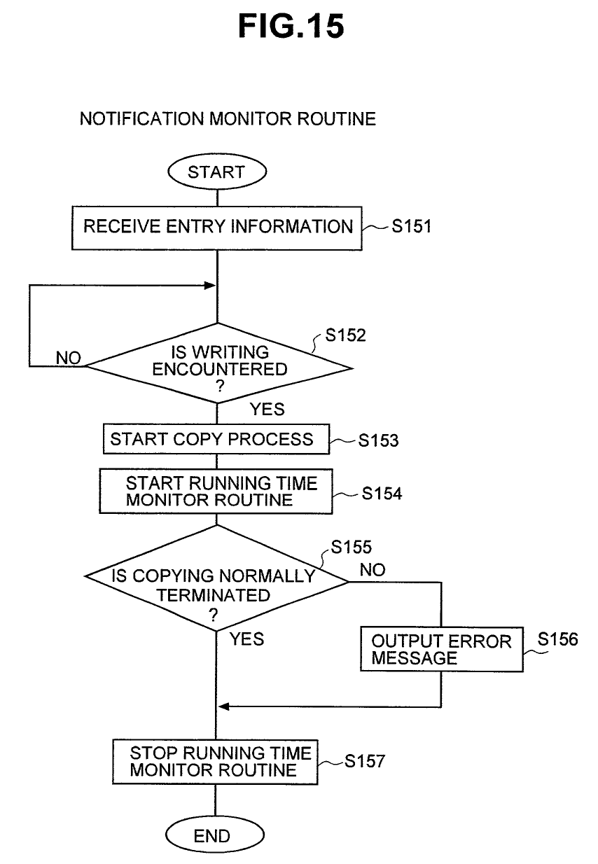

A notification monitor routine for monitoring the occurrence of a restore requirement from the already existing program when the restore mode is given a as notification, will next be explained with reference to FIG. 15. The present routine is a process started from Step S88 of the copy process controller of FIG. 8, making a decision as to the presence or absence of notification issued from the interface 25 by referring to the configuration table 32, and starting up the copy processor 24 when the notification is issued therefrom.

After the starting of the present routine, the copy process controller 23 first receives information about the corresponding entry in the configuration table 32 (Step S151). Further, the copy process controller 23 determines by reference to the presence or absence of restore notification of the corresponding entry whether the notification is issued (Step S152).

If the answer is found to be YES in Step S152, then the copy process controller 23 starts up the copy processor 24 and starts a running time monitor routine (Step S154). If the answer is found to be NO in Step S152, then the copy process controller 23 continues to monitor.

Thereafter, the copy process controller 23 determines whether the operation of the copy processor 24 is normally terminated (Step S155). If the answer is found to be YES in Step S155, then the copy process controller 23 stops the running time monitor routine (Step S157) and terminates the present routine.

If it is determined in Step S155 that the operation of the copy processor 24 is not normally terminated, then the copy process controller 23 outputs an error message through the I/O device 30 and proceeds to a running time monitor stop in Step S157.

A description will next be made of a process or routine of the interface 25 at the time that the restore mode is given as a notification.

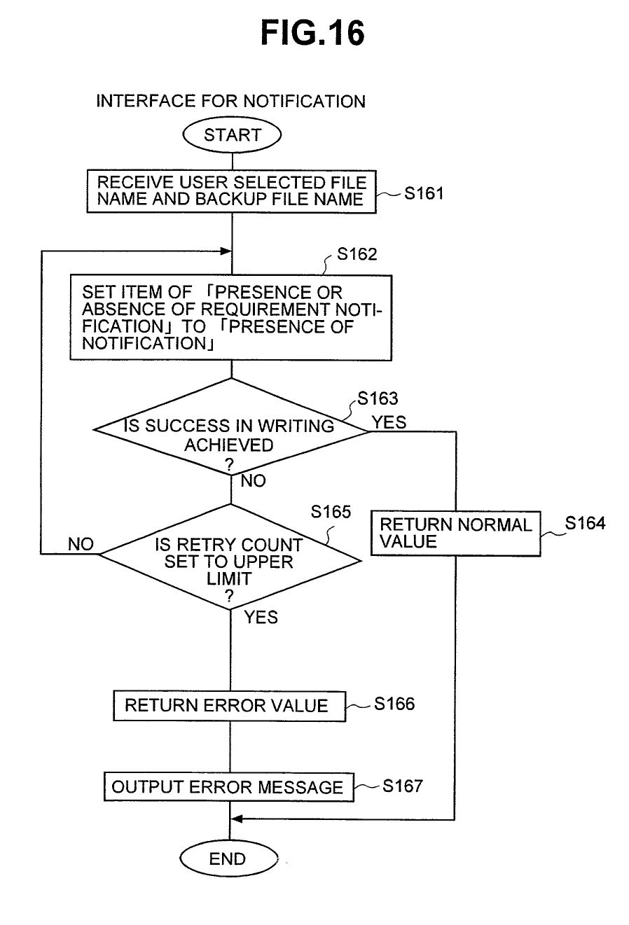

FIG. 16 is a flowchart showing an example of a processing operation of the interface shown in FIG. 1.

The present routine is called from the APP 40 when the notification is specified to the restore mode of the configuration table 32 of FIG. 1 to thereby notify an execution opportunity of restoration to the main routine 20. First, the interface 25 invokes the present means and receives a user selected file name and a backup file name as parameters from a call source in the format shown in FIG. 13 (Step S161).

The interface 25 obtains the corresponding entry in the configuration table 32 from the contents of the parameters and writes the occurrence of notification into the item of the notify status (Step S162). Thereafter, the interface 25 determines whether the writing of Step S162 is normally done (Step S163). If the answer is found to be YES in Step S163, then the interface 25 returns a normal value to call source (Step S164) and terminates the present process.

If the answer is found to be NO in Step S163, then the interface 25 determines whether a retry count has reached its upper limit (Step S165). If the answer is found to be NO in Step S165, then the interface is returned to the notification area writing of Step S162 to continue writing. If the answer is found to be YES in Step S165, then the interface 25 returns an error value to the call source (Step S166) and outputs an error message through the IIAD device 30 (Step S167). Thereafter, the interface 25 terminates the process.

Incidentally, the call source may arbitrarily handle a normal value and an error value returned according to the present processes in Steps S164 and S165.

Three types are provided as call opportunities of the present means at the time that the restore mode is given as a notification. They differ from each other depending on whether the APP 40 reads data from the user selected file 34 or writes data therein.

When the APP 40 reads data therefrom, for example, the APP 40 may perform calling upon error detection through the process of the APP 40 for referring to the user selected file 34.

When the APP 40 writes data therein, the opportunities differ from each other for each of the contents specified to the backup mode. When the backup mode is given as updating, the backup is obtained each time one data item is written. Therefore, the call source may perform calling each time it detects that the writing of data into the user selected file results in an error. When the backup mode is specified as updating complete, the call source may carry out calling each time it detects an error developed in update close of the user selected file.

An error monitor routine of the copy process controller 23, which is started in Step S89 of FIG. 8, will next be described.

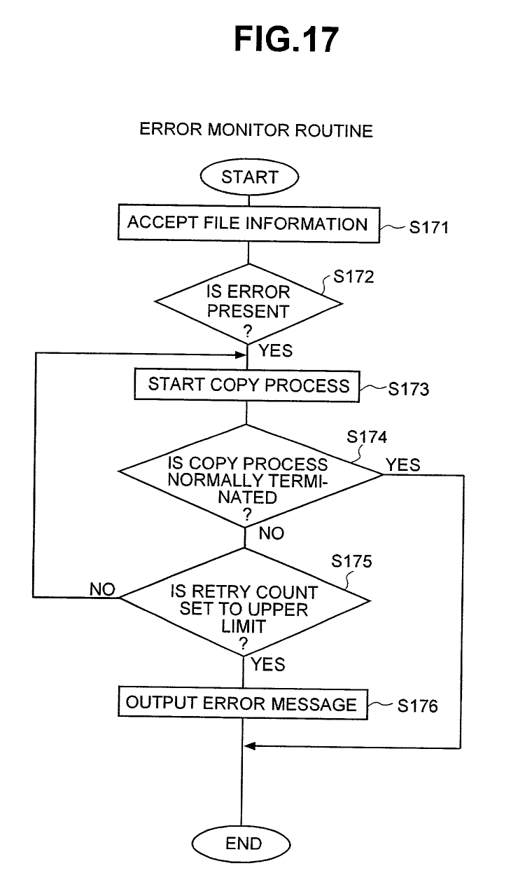

FIG. 17 is a flowchart showing an example of an error monitor routine operation started by the copy process controller shown in FIG. 1.

The present routine is used to monitor the occurrence of errors in the input/output of data to and from the user selected file 34, and to start up the copy processor 24 upon the occurrence of errors to thereby execute restoration. Incidentally, the errors to be monitored herein include a data read error, a data write error and an error of file closing subsequent to the data writing.

After the starting of the present routine, the copy process controller 23 first receives information about the corresponding entry (Step S171). Next, the copy process controller 23 starts to monitor the corresponding user selected file 34 from the received information and determines the presence or absence of the occurrence of an error (Step S172). When the error occurs, the copy process controller 23 sends the entry information to the copy processor 24 to start up the copy processor 24 (Step S173).

Further, the copy process controller 23 determines whether the operation of the copy processor 24 is normally terminated (Step S174). If the answer is found to be NO in Step S174, then the copy process controller 23 determines whether a retry count has reached an upper limit (Step S175). If the answer is found to be NO in Step S175, then the copy process controller 23 returns to the main routine to start up the copy processor 24 again. If the answer is found to be YES in Step S175, then the copy process controller 23 outputs an error message through the I/O device 30 (Step S176) and terminates the main routine.

In the file backup system according to the present embodiment, as has been described above using FIGS. 1 through 17, only a user-designated file is backed up by software. This makes it possible to implement the backup of the file system at low cost.

Further, the procedures for the backup processing include a sequence for obtaining backup at an opportunity when the user selected file is closed after its updating, and a sequence for obtaining backup at an opportunity when the data writing occurs while the user selected file is being updated. Therefore, when the novelties required for the backup information differ according to the contents and applications of a file to be backed up, e.g., even when it is necessary to obtain backup at a plurality of different frequencies such as in the case of the acquisition of backup with a high frequency so as to obtain backup each time the writing of data into the file to be backed up occurs once, the acquisition of backup with a frequency lower than the former so as to obtain backup each time the writing of the data into the file is completed and the file closing is done, etc., and when a plurality of files to be backed up exist, the correspondence of respective files and a plurality of backup acquisition opportunities can be managed by the aforementioned table. It is therefore possible to customize the backup operation according to a user's activities.

Further, the procedures to restore processing include a sequence of operations for restoring a file when a failure occurs in a user selected file, a sequence of operations for executing restoration by a user's manual operation at an arbitrary point in time, and a sequence of operations for restoring a file at an opportunity required from an arbitrary program using a user selected file. Thus, the file restoration can be done without effecting a modification of the APP and creating a new program for purposes of file restoration, thereby making it possible to reduce the burden on a user.

Incidentally, the present invention is not necessarily limited to the embodiment described with reference to FIGS. 1 through 17. Various changes can be made thereto within a scope not departing from the substance of the invention. While the user selected file 34 and the backup file 33 are respectively provided as shown in FIG. 1 in the preset embodiment, for example, they may be respectively constructed to exist in plural form according to a user's applications.

According to the present invention, since a user obtains backup for only a file (selected file) that the user desires to back up, the file backup can be performed with less hard-disk capacity and hence the file backup can be implemented with an inexpensive capital investment of hardware.

Further, the user can select a sequence of operations for executing restoration without modifying the already-exiting program. For example, another program can be involved in the restore execution by sending a restore execution request from another program. Thus, plurality of restore sequences corresponding to a user's needs can be selected.

What is claimed is:

1. A data backup system for backing up data used in a computer comprising:
a memory for storing data in a unit of a file;
a table for storing a plurality of file names to be backed up and backup timings corresponding to said file names;
copying means for backing up data in said memory based on said file names and said backup timings; and
setting means for receiving said file names and said backup timings and setting said file names and said backup timings to said table.

2. The data backup system according to claim 1, further comprising:
user data restore means for updating the contents of data copied by said copying means when a file write error occurs, thereby restoring the data.

3. The data backup system according to claim 1, wherein timings can be defined for copying the contents of data.

4. The data backup system according to claim 3, wherein said defined timings include at least one of timing provided when said data is updated and timing provided when a file including said data is closed after having been updated.

5. The data backup system according to claim 2, wherein said user data restore means has defining means for defining conditions for restoring the data.

6. The data backup system according to claim 5, wherein said defining means is capable of defining at least one of a condition used when an input/output failure occurs in data, a condition used when a data restore requirement is issued from an application program for accessing data, and a condition used when a data restore requirement is issued from a user.

7. A data backup method of backing up data used in a computer, comprising the steps of:
storing, in a memory, data in a unit of a file;
storing, in a table, a plurality of file names to be backed up and backup timings corresponding to said file names;
backing up, by copying means, data into said memory based on said file names and said backup timings; and
receiving said file names and said backup timings and setting said file names and said backup timings to said table.

8. The data backup method according to claim 7, further comprising a step of:
allowing a user data restore means to update the contents of data copied by the copying means when a file write error occurs, thereby restoring the data.

9. A data storage capable of being read by a computer having stored thereon a program for backing up data used in said computer, said program when executed causes said computer to perform the steps of:
storing, in a memory, data in a unit of a file;
storing, in a table, a plurality of file names to be backed up and backup timings corresponding to said file names;
backing up, by copying means, data into said memory based on said file names and said backup timings; and
receiving said file names and said backup timings and setting said file names and said backup timings to said table.

10. A data storage capable of being read by a computer having stored thereon a program for backing up data used in said computer, said program when executed causes said computer to perform the steps of:
storing, in a memory, data in a unit of a file;
storing, in a table, a plurality of file names to be backed up and backup timings corresponding to said file names;
backing up, by copying means, data into said memory based on said file names and said backup timings;
receiving said file names and each backup timings and setting said file names and said backup timings to said table; and
allowing a user data restore means to update the contents of data copied by the copying means when a file write error occurs, thereby restoring the data.

11. A data backup system for backing up data used in a computer comprising:
a memory for storing data in a unit of a file;
a table for storing a plurality of file names to be backed up and backup timings corresponding to each of said file names;
first copying means for backing up data into said memory when data is written;
second copying means for backing up data into said memory when a file is closed;
means for causing said first copying means or said second copy means to function based on said file names and said backing up timings; and
setting means for receiving said file names and said backup timings and setting said file names and said backup timings to said table.
